(19) United States
(12) Patent Application Publication
(10) Pub. No.: US 2016/0327700 A1
(43) Pub. Date: Nov. 10, 2016

(54) REFLECTIVE SHEET

(71) Applicant: 3M INNOVATIVE PROPERTIES COMPANY, St. Paul, MN (US)

(72) Inventors: John A. Wheatley, Lake Elmo, MN (US); Glendon D. Kappel, Eagan, MN (US); Scott E. Simons, Forest Lake, MN (US); Andrew H. Tilstra, Shoreview, MN (US)

(21) Appl. No.: 15/146,628

(22) Filed: May 4, 2016

Related U.S. Application Data
(60) Provisional application No. 62/156,727, filed on May 4, 2015.

(51) Int. Cl. G02B 5/08; G02B 5/02

(52) U.S. Cl. CPC G02B 5/0841; G02B 5/0808; G02B 5/0284

(57) ABSTRACT

Reflective sheets are described. In particular, flat reflective sheets including reflectors and substrates are described. The reflective sheets may have at least one edge not parallel to any other edge. The reflective sheets may also include at least one tab. Other films may be attached or adhered to either the reflector or the substrate.

### BACKGROUND

Reflective sheets reflect incident light. Such sheets may be specularly reflective (mirror-like) or diffusely reflective. Various substrates are used in particular applications to provide rigidity or dimensional stability.

### SUMMARY

In one aspect, the present description relates to a flat reflective sheet. The flat reflective sheet includes a substrate bendable beyond its yield point without fracture and a reflector disposed on the substrate. At least one edge of the reflective sheet is not parallel with any other edge of the reflective sheet.

In another aspect, the present description relates to a flat reflective sheet include a substrate, bendable beyond its yield point without fracture, and a reflector disposed on the substrate. The flat reflective sheet also includes at least one tab.

### BRIEF DESCRIPTION OF THE DRAWINGS

FIG. 1 is a top plan view of a reflective sheet.

FIG. 2 is a side elevation cross section of a reflective sheet.

FIG. 3 is a side elevation cross section of a reflective sheet.

FIG. 4 is a side elevation cross section of a reflective sheet.

FIG. 5 is a side elevation cross section of a reflective sheet.

FIG. 6 is a top plan view of a reflective sheet.

### DETAILED DESCRIPTION

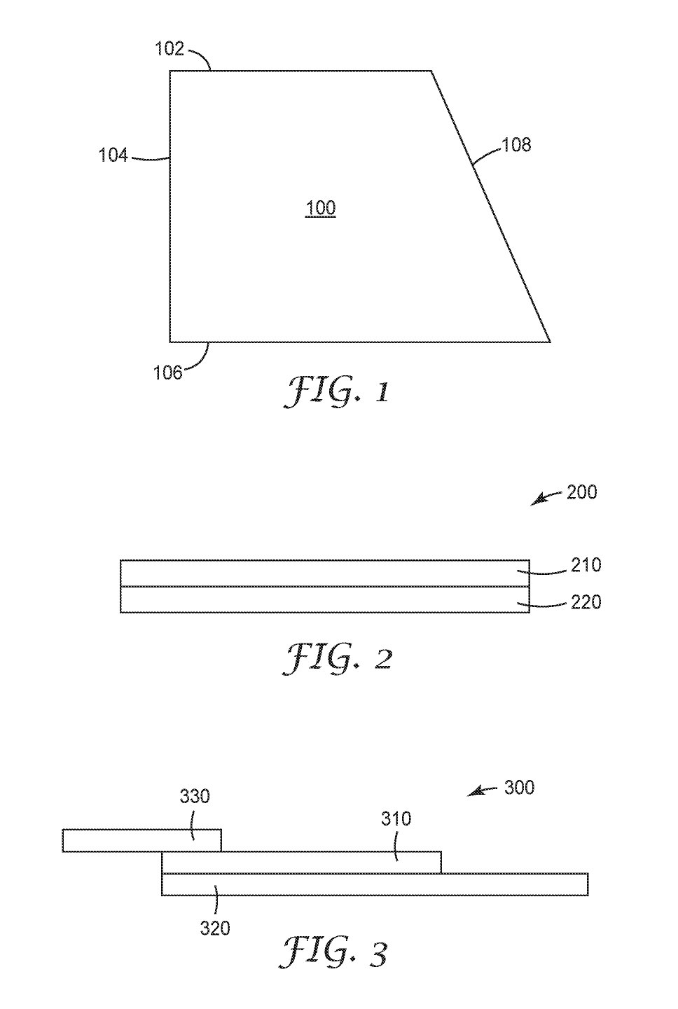

FIG. 1 is a top plan view of a reflective sheet. Reflective sheet 100 includes top edge 102, left edge 104, bottom edge 106, and right edge 108. The particular shape and size of reflective sheet 100 is exemplary and may vary depending on the desired application.

Left edge 104 and right edge 108 are non-parallel. In fact, right edge 108 is not parallel with any other edge of the reflective sheet. In some embodiments, the shape of reflective sheet 100 is more complicated than the quadrilateral shown in FIG. 1: however, the simple case is shown for ease of illustration. Other polygonal, curved, and faceted shapes are possible for reflective sheet 100. In any case, however, at least one edge (i.e., one side or facet) is not parallel with any other edge of the reflective sheet.

Reflective sheet 100 is a flat sheet formed from a reflector being disposed on a substrate, where the substrate is a substrate that is bendable beyond its yield point without fracture. The reflector and the substrate may fully overlap (as shown in FIG. 1) or only partially overlap.

Reflectors that may be suitable for reflective sheet 100 include a specular reflector, such as Enhanced Specular Reflector (“ESR”) (available from 3M Company, St. Paul, Minn.). In some embodiments, such as for ESR, the reflector is a multilayer polymeric reflector. In some embodiments, the reflector is a silver reflector. In some embodiments, the reflector is spectrally neutral over across visible wavelengths. In some embodiments, the reflector is a semi-specular reflector or a diffuse reflector. Specularity refers to the degree of specular reflection for light incident on the reflector's surface. Specular reflectors provide a single reflection angle for a single incidence angle, diffuse reflectors provide a broad or even Lambertian reflection pattern for a single incidence angle, and semi-specular reflectors provide a reflection characteristic somewhere in between. For example, semi-specular reflection may be usefully characterized by its transport ratio, which may be given as the ratio of the difference of forward scattered light and back scattered light to the total light. Transport ratios of 0.7 or greater, as an example, may be useful to help transport light while providing enough scattering (albeit forward scattering) to hide defects and enhance uniformity.

The reflector may be made of multiple reflective layers; for example, the reflector may include portions of a diffuse reflector placed over a specular reflector. In some embodiments, there may be printed dots on the reflector to provide a diffuse reflectivity at those points. Any of the optical characteristics of the reflector may vary along one or more directions; for example, in a gradient or pattern.

The substrate may be any suitable substrate that is bendable beyond its yield point without fracture. In some embodiments, the substrate may be a paper or wood pulp material. For example, the substrate may be or include card stock, paperboard, or cardboard, and may include recycled or post-consumer material. In some embodiments, the substrate may be plastic or polymeric. For example, the substrate may include sheet stock, corrugated plastic, or double and triple walled plastic, and may include recycled or post-consumer material. In some embodiments, the substrate may be photodegradable, biodegradable, or compostable. In some embodiments, the substrate may be flame or fire retardant or resistant (and may make the reflective sheet overall flame or fire retardant or resistant). The substrate may be any suitable thickness depending on the desired application. In some embodiments, the substrate may retain its shape and size after being cycled through high heat and/or humidity. In some embodiments, the substrate may be dimensionally stable or resist curl. In some embodiments, the substrate may be non-conductive. In some embodiments, the substrate may be or include a composite material, such as fiber-reinforced plastic (FRP), including fiberglass. In some embodiments, the substrate may be a metal or a foam core material, such as two aluminum sheets with a polypropylene or polyethylene core. The substrate may be printable—that is, it may be capable of being printed on.

The reflective sheet may have one or more perforations. In some embodiments, the perforations are along a narrow portion of the reflective sheet. In some embodiments, the perforations become more numerous or larger along a direction. In some embodiments, the perforations are along a line. In some embodiments, the perforations are evenly spaced. In some embodiments, reflective sheet 100 includes at least one slit. In some embodiments, the reflective sheet includes at least one polygonal or circular opening or any other opening with one or more flat or curved sides. In some embodiments, the reflective sheet is scored in at least one place or along at least one line.

FIG. 2 is a side elevation cross section of a reflective sheet. Reflective sheet 200 includes reflector 210 is disposed on substrate 220. The relative thicknesses of the reflector and the reflective sheet are not necessarily to scale. Reflector 210 completely overlaps substrate 220. Reflector 210 may be attached to substrate 220 permanently or removably, by any suitable adhesive or process. In some embodiments, reflector 210 is attached to substrate 220 via an adhesive or glue. In some embodiments, reflector 210 is attached to substrate 220 via double sided tape. In some embodiments, reflector 210 is coextruded with or laminated to substrate 220. In some embodiments, from a plan view, a portion up to half of the area of the reflective sheet is not a reflector.

FIG. 3 is a side elevation cross section of a reflective sheet. Reflective sheet 300 includes reflector 310 disposed on substrate 320 and film 330 disposed on reflector 310. As illustrated in FIG. 3, reflector 310 need not entirely overlap substrate 320. Further, film 330 is disposed on reflector 310. For at least a portion of reflective sheet 300, film 330 is disposed on reflector 310 disposed on substrate 320; in other words, the construction of reflective sheet 300 is three layers at at least one point.

Film 330 may be any suitable material or component. In some embodiments, film 330 may be a structured film. In some embodiments, film 330 may have a microstructured surface. In some embodiments, film 330 may have two microstructured surfaces. These microstructured surfaces and films may be formed from any suitable process, including an ultraviolet cast-and-cure process, an embossing process, a two-photon process, or an injection molding process. In some embodiments, film 330 may be a prism film, such as Brightness Enhancing Film (BEF), available from 3M Company, St. Paul, Minn. In some embodiments, film 330 may be a light redirecting film. In some embodiments, film 330 may be a transflective film. In some embodiments, film 330 may be a reflective polarizer. In some embodiments, film 330 may be a turning film. In some embodiments, film 330 may have elongated lens or cylindrical structures. In some embodiments where film 330 has top and bottom structures, these structures may be oriented orthogonally to one another In some embodiments with top and bottom structures, these structures may be registered. Film 330 may be or include a collimating multilayer optical film, a partial mirror film, an absorber or color filter, a downconverter including phosphors, fluorescers, or quantum dots, a color shifting film, or a diffuser (with one or more of bulk or surface scattering). In some embodiments, film 330 may include a non-woven component. In some embodiments, film 330 may include transparent, translucent, clear, or hazy plastic or flexible glass. In some embodiments, film 330 can have spatially varying optical properties.

Film 330 may be attached or otherwise adhered to reflective sheet 300, and specifically reflector 310, by a repositionable adhesive or microstructured adhesive, by pressure sensitive adhesive, by a hook-and-loop or other mechanical fastener system, by optically clear adhesive including UV-curable optically clear adhesive, by acrylic foam tape, by a sprayable adhesive, or by a liquid optically clear adhesive. Film 330 may be permanently or removably or repositionably attached. Film 330 may include an adhesive with a removable liner attached.

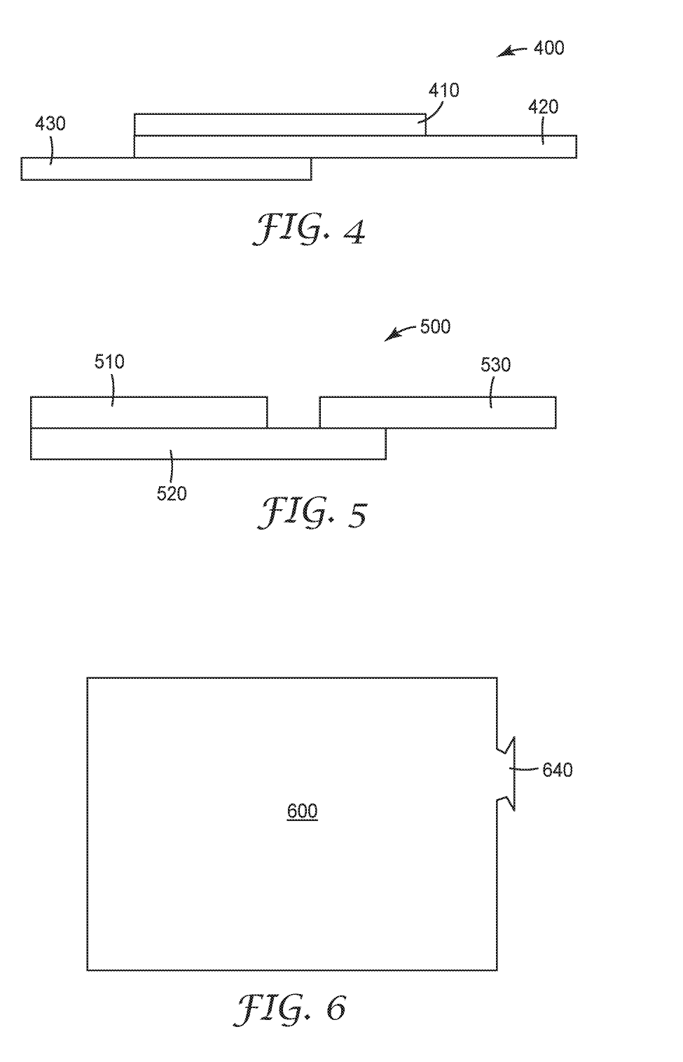

FIG. 4 is a side elevation cross section of a reflective sheet. Reflective sheet 400 includes reflector 410, substrate 420, and film 430. In FIG. 4, film 430 is disposed on the substrate, on the opposite side of reflector 410. Film 430 may be attached to substrate 420 in any of the ways as described in FIG. 3 for the corresponding film 330 and reflector 310. In some embodiments, and as shown in FIG. 4, the majority of the film may not be disposed on the substrate.

FIG. 5 is a side elevation cross section of a reflective sheet. Reflective sheet 500 includes reflector 510, substrate 520, and film 530. In FIG. 5, film 530 is disposed on the substrate, but on the same side as the reflector. Film 530 and reflector 510 may be adjacent or touching or they may have space or a gap between them. In some embodiments, reflective sheet 500 may have more than one film attached.

FIG. 6 is a top plan view of a reflective sheet. Reflective sheet 600 includes tab 640. Tab 640 extends beyond the rest of an edge of reflective sheet 600 and is much smaller than the total length of the edge. Reflective sheets described herein may have a combination of tabs and edges that are not parallel to any other edge. Reflective sheet 600 may include a strip or array of LEDs or OLEDs (or any other suitable light source) placed over the reflective sheet. The LEDs or OLEDs may emit any suitable color or combination of colors of light. The light sources may be driven by suitable electronics and may be adhered permanently or removably to the reflective sheet.

Descriptions for elements in figures should be understood to apply equally to corresponding elements in other figures, unless indicated otherwise. The present invention should not be considered limited to the particular examples and embodiments described above, as such embodiments are described in detail in order to facilitate explanation of various aspects of the invention. Rather, the present invention should be understood to cover all aspects of the invention, including various modifications, equivalent processes, and alternative devices falling within the scope of the invention as defined by the appended claims and their equivalents.

What is claimed is:

1. A flat reflective sheet, comprising:
a substrate, bendable beyond its yield point without fracture; and
a reflector disposed on the substrate;
wherein at least one edge of the reflective sheet is not parallel with any other edge of the reflective sheet.

2. The reflective sheet of claim 1, wherein the reflector is a polymeric multilayer reflector.

3. The reflective sheet of claim 1, wherein the reflective sheet further comprises a plurality of perforations.

4. The reflective sheet of claim 1, wherein the reflective sheet further comprises at least one slit.

5. The reflective sheet of claim 1, wherein a portion up to half of the area of the reflective sheet, from a plan view, is not a reflector.

6. The reflective sheet of claim 1, further comprising a microstructured film.

7. The reflective sheet of claim 6, wherein a majority of the microstructured film is not disposed on the substrate.

8. The reflective sheet of claim 6, wherein the microstructured film is attached to the reflector.

9. The reflective sheet of claim 1, wherein the reflective sheet is scored along one or more of its length or width.

10. A flat reflective sheet, comprising:
a substrate, bendable beyond its yield point without fracture; and
a reflector disposed on the substrate; and
at least one tab.

11. The reflective sheet of claim 10, wherein the substrate is paperboard.

12. The reflective sheet of claim 10, wherein the substrate is cardboard.

13. The reflective sheet of claim 10, wherein the substrate is a polymer.

14. The reflective sheet of claim 10, further comprising at least one slit.

15. The reflective sheet of claim 10, further comprising a microstructured film.

16. The reflective sheet of claim 15, wherein the microstructured film is at least partially disposed behind the reflector.

17. The reflective sheet of claim 15, wherein the microstructured film is at least partially disposed behind the substrate.

18. The reflective sheet of claim 10, wherein the reflector is a silver reflector.

19. The reflective sheet of claim 10, wherein the reflector is a polymeric multilayer reflector.
